(19) United States
(12) Patent Application Publication
(10) Pub. No.: US 2009/0316049 A1
(43) Pub. Date: Dec. 24, 2009

(54) Image processing apparatus, image processing method and program

(75) Inventor: Kazuhiro Fuji, Kanagawa (JP)

Correspondence Address: FOLEY AND LARDNER LLP;SUITE 500, 3000 K STREET NW, WASHINGTON, DC, 20007, US

(73) Assignee: NEC Electronics Corporation

(21) Appl. No.: 12/453,202

(22) Filed: May 1, 2009

(30) Foreign Application Priority Data
Jun. 18, 2008 (JP) 2008-158960

(51) Int. Cl. H04N 5/21; G06K 9/48

(52) U.S. Cl. 348/625; 382/199; 348/E05.077

(57) ABSTRACT

An edge detection unit performs edge detection on a frame of a moving image. A vertical line extraction unit of a block vertical boundary position detection unit extracts a vertical edge having an intensity equal to or lower than a noise determination threshold from edges detected by the edge detection unit. A vertical counter counts a total number of edges extracted by the vertical line extraction unit with respect to each pixel line position of the frame. A block vertical boundary position determination unit determines a pixel line position having a peak of a count value of the vertical counter as a block vertical boundary position. A block horizontal boundary position detection unit performs the same processing as the block vertical boundary position detection unit on a horizontal edge among edges detected by the edge detection unit and detects a block horizontal boundary position.

### BACKGROUND

1. Field of the Invention

The present invention relates to image processing technology and, particularly, to a technique of detecting block noise from a moving image.

2. Description of Related Art

A moving image is generally compressed before being stored or transmitted in order to reduce storage capacity or increase a transmission speed. When playing back a compressed moving image, block noise due to compression causes degradation of playback image quality. Thus, processing for reducing the effect of block noise is performed when playing back the moving image.

Prior to reducing block noise, it is necessary to detect block noise, or a block boundary, and various techniques are proposed for that.

For example, a technique disclosed in Japanese Unexamined Patent Publication No. 2000-50275 applies a horizontal HPF (High-Pass Filter) and a vertical HPF to frames of a moving image and extracts high-frequency components each in the horizontal and vertical directions. Then, the absolute values of the extracted high-frequency components are added together respectively in the horizontal and vertical directions, thereby obtaining a horizontal one-dimensional signal and a vertical one-dimensional signal respectively having peak values in the horizontal and vertical cycles. Then, horizontal peak value positions and vertical peak value positions are detected as block boundary positions based on the horizontal one-dimensional signal and the vertical one-dimensional signal.

The technique disclosed in Japanese Unexamined Patent Publication No. 2000-50275 detects the peak value positions of the cumulative added value of the absolute values of high-frequency components in the horizontal direction and the peak value positions of the cumulative added value of the absolute values of high-frequency components in the vertical direction as the block boundary positions utilizing that block noise appears as a vertical line and a horizontal line in frames of the compressed moving image.

### SUMMARY

There is, however, a case where a vertical line and a horizontal line exist in an original image pattern, in addition to the vertical line and the horizontal line of block noise, in the frames. In such a case, accuracy to detect block noise is degraded unless the vertical line and the horizontal line of the image pattern are distinguished from the vertical line and the horizontal line of block noise.

Further, the technique disclosed in Japanese Unexamined Patent Publication No. 2000-50275 detects the peak value positions that appear periodically as the block boundary positions. In a frame of a moving image, however, processing of copying a block image of another frame or the like is performed at the time of compression, and therefore the block boundary positions do not always appear periodically. In the case of the frame where the block boundaries do not appear periodically, block noise cannot be detected using the technique disclosed in Japanese Unexamined Patent Publication No. 2000-50275.

An exemplary aspect of an embodiment of the present invention is an image processing apparatus. The image processing apparatus includes an edge detection unit, a vertical line extraction unit, a horizontal line extraction unit, a vertical counter, a horizontal counter, and a block boundary position determination unit.

The edge detection unit performs edge detection on a frame of a moving image. The vertical line extraction unit extracts a vertical edge having an intensity equal to or lower than a noise determination threshold from edges detected by the edge detection unit. The horizontal line extraction unit extracts a horizontal edge having an intensity equal to or lower than the noise determination threshold from the edges detected by the edge detection unit.

The vertical counter counts a total number of edges extracted by the vertical line extraction unit with respect to each pixel line position of the frame. The horizontal counter counts a total number of edges extracted by the horizontal line extraction unit with respect to each pixel row position of the frame.

The block boundary position determination unit determines a pixel line position having a peak of a count value of the vertical counter as a block vertical boundary position and determines a pixel row position having a peak of a count value of the horizontal counter as a block horizontal boundary position.

The implementation of the image processing apparatus according to the above exemplary aspect as a system, a method or a program causing a computer to operate as the above-described apparatus is also effective as another exemplary aspect of an embodiment of the present invention.

According to the exemplary aspects of an embodiment of the present invention described above, it is possible to reliably and accurately detect block noise from frames of a moving image.

### BRIEF DESCRIPTION OF THE DRAWINGS

The above and other exemplary aspects, advantages and features will be more apparent from the following description of certain exemplary embodiments taken in conjunction with the accompanying drawings, in which:

FIG. 1 is a view showing an image processing apparatus according to an exemplary embodiment of the present invention;

FIG. 2 is a view showing a block boundary position detection unit in the image processing apparatus shown in FIG. 1;

FIG. 3 is a view showing a block vertical boundary position detection unit in the block boundary position detection unit shown in FIG. 2;

FIG. 4 is a flowchart showing a flow of processing in the block vertical boundary position detection unit shown in FIG. 3;

FIG. 5 is another flowchart showing a flow of processing in the block vertical boundary position detection unit shown in FIG. 3; and

FIG. 6 is a view showing a block horizontal boundary position detection unit in the block boundary position detection unit shown in FIG. 2.

### DETAILED DESCRIPTION OF THE EXEMPLARY EMBODIMENTS

An exemplary embodiment of the present invention will be explained hereinbelow with reference to the drawings. Elements that are shown as functional blocks for performing various kinds of processing in the drawings used for the explanation hereinbelow may be configured by a processor, memory or another circuit as hardware or may be implemented by a program stored in or loaded to memory as software. It would be thus obvious to those skilled in the art that those functional blocks may be implemented in various forms such as hardware only, software only or a combination of those, and not limited to either one. Further, only the elements that are necessary for explaining the technique of the present invention are shown in the drawings in order to facilitate understanding.

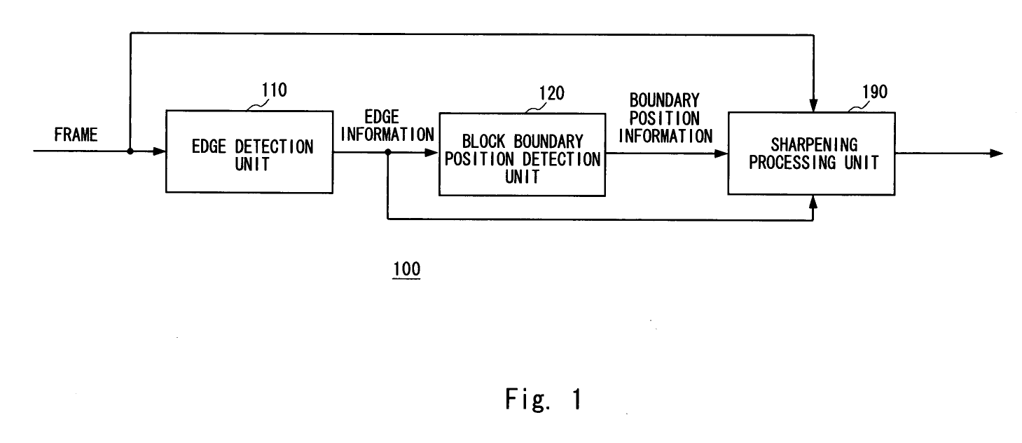

FIG. 1 shows an image processing apparatus 100 according to an exemplary embodiment of the present invention. The image processing apparatus 100 includes an edge detection unit 110, a block boundary position detection unit 120, and a sharpening processing unit 190.

The edge detection unit 110 performs edge detection on sequentially input frames of a moving image and outputs obtained edge information to the block boundary position detection unit 120 and the sharpening processing unit 190. A technique of the edge detection by the image processing apparatus 100 may be any known technique such as differentiation filtering, and the edge information obtained by the edge detection unit 110 contains the direction, intensity and position of each edge.

The block boundary position detection unit 120 detects the positions of block noise, which is block boundary positions, in the frames of the moving image using the edge information from the edge detection unit 110 and outputs boundary position information indicating those positions to the sharpening processing unit 190. The boundary position information contains vertical boundary position information indicating the position of the block boundary extending in the vertical direction and horizontal boundary position information indicating the position of the block boundary extending in the horizontal direction.

The sharpening processing unit 190 performs sharpening processing on the frames of the moving image by referring to the edge information from the edge detection unit 110 and the boundary position information from the block boundary position detection unit 120. The detail of the sharpening processing unit 190 is described later.

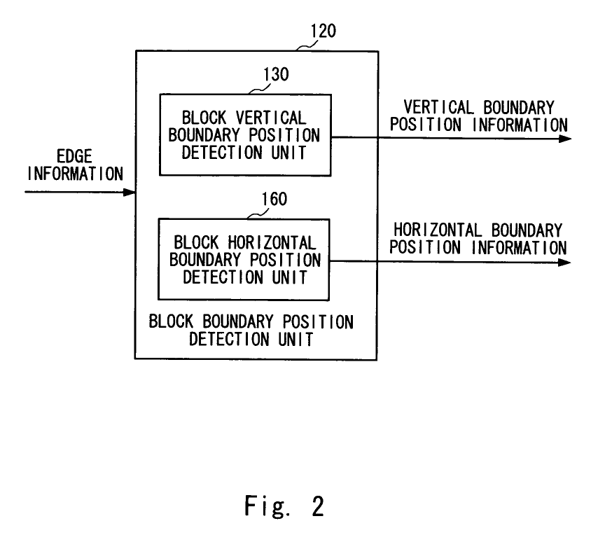

FIG. 2 shows the configuration of the block boundary position detection unit 120. The block boundary position detection unit 120 includes a block vertical boundary position detection unit 130 and a block horizontal boundary position detection unit 160. The block vertical boundary position detection unit 130 detects the position of the block boundary extending in the vertical direction and obtains the vertical boundary position information. The block horizontal boundary position detection unit 160 detects the position of the block boundary extending in the horizontal direction and obtains the horizontal boundary position information.

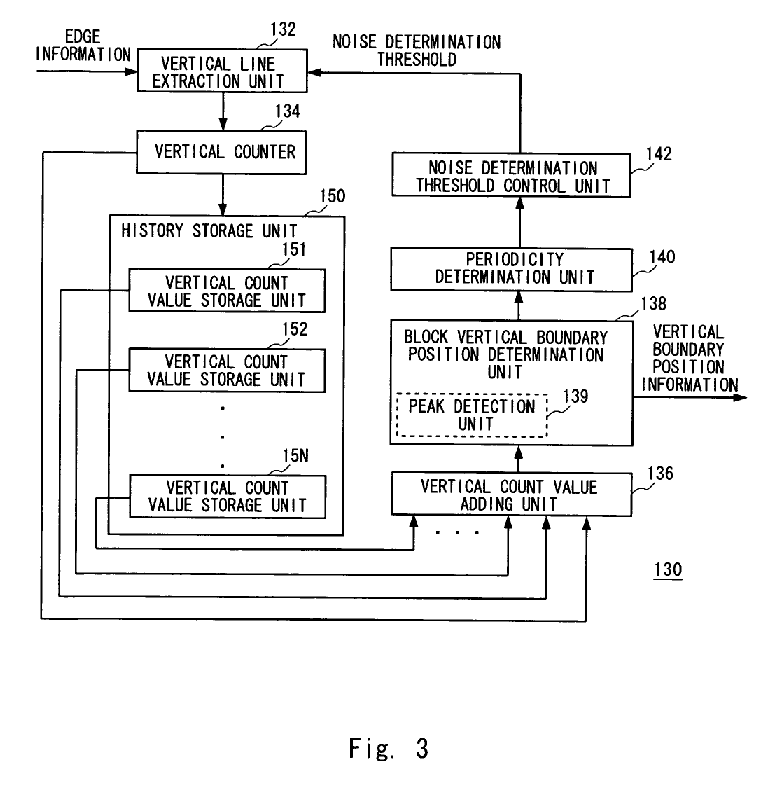

FIG. 3 shows the configuration of the block vertical boundary position detection unit 130. The block vertical boundary position detection unit 130 includes a vertical line extraction unit 132, a vertical counter 134, a history storage unit 150, a vertical count value adding unit 136, a block vertical boundary position determination unit 138, a periodicity determination unit 140, and a noise determination threshold control unit 142.

The vertical line extraction unit 132 extracts vertical edges having an intensity that is equal to or lower than a noise determination threshold from all the edges indicated by the edge information from the edge detection unit 110, and outputs the positions of the extracted edges to the vertical counter 134. The noise determination threshold that is used by the vertical line extraction unit 132 is set by the noise determination threshold control unit 142, which is described later.

The vertical counter 134 counts the total number of edges extracted by the vertical line extraction unit 132 with respect to each pixel line position of the currently processed frame and obtains a vertical count value. The vertical counter 134 outputs the vertical count value of each pixel line position to the history storage unit 150 and the vertical count value adding unit 136.

The history storage unit 150 includes N-number (N is an integer of one or larger) of vertical count value storage units 151 to 15N, and the vertical count value storage units 151 to 15N respectively store the vertical count values of the N-number of frames that have been processed before the currently processed frame.

For example, when N is 3, the vertical count value storage unit 15N stores the vertical count values of the frame that is three frames before the frame currently processed by the vertical counter 134, the vertical count value storage unit 152 stores the vertical count values of the frame that is two frames before the currently processed frame, and the vertical count value storage unit 151 stores the vertical count values of the frame that is one frame before the currently processed frame.

When the vertical counter 134 processes the first frame, none of the vertical count value storage units of the history storage unit 150 stores any vertical count value. When the vertical counter 134 processes the second frame, the vertical count value storage unit 151 stores the vertical count values of the first frame, and the vertical count value storage unit 152 and the vertical count value storage unit 15N do not store any vertical count value.

In the following description about the image processing apparatus 100 according to the exemplary embodiment, N is assumed to be 3.

The vertical count value adding unit 136 adds the vertical count value of the current frame that is output from the vertical counter 134 and the vertical count values of the previous frames that are stored in the respective vertical count value storage units of the history storage unit 150 with respect to each corresponding pixel line position. The vertical count value storage unit that does not store any vertical count value is not used for the addition.

Specifically, the vertical count value adding unit 136 adds the vertical count values of a plurality of frames in each pixel position in the horizontal direction. The vertical count value adding unit 136 outputs the vertical count values of each pixel line position obtained as above to the block vertical boundary position determination unit 138.

The block vertical boundary position determination unit 138 includes a peak detection unit 139. The peak detection unit 139 detects the peak of each vertical count value from the vertical count value adding unit 136.

If the vertical count values output from the vertical counter 134 are those of the frame that is before the fourth frame, the block vertical boundary position determination unit 138 outputs the position of each peak detected by the peak detection unit 139 to periodicity determination unit 140. The position of the peak coincides with each pixel line position where the peak is detected. On the other hand, if the vertical count values output from the vertical counter 134 are those of the fourth frame, the block vertical boundary position determination unit 138 determines the position of each peak detected by the peak detection unit 139 as a block vertical boundary position and outputs vertical boundary position information indicating block vertical boundary positions to the sharpening processing unit 190.

Periodicity determination unit 140 determines the presence or absence of periodicity of the peak positions from the block vertical boundary position determination unit 138. If periodicity is present, which is, if the peak positions are equally spaced, periodicity determination unit 140 determines that there is periodicity and outputs information indicating a period boundary position to the noise determination threshold control unit 142. The period boundary position is identical to the peak position from the block vertical boundary position determination unit 138. If periodicity determination unit 140 determines that there is no periodicity, it notifies that to the noise determination threshold control unit 142.

The noise determination threshold control unit 142 sets the noise determination threshold that is used in the extraction processing by the vertical line extraction unit 132. The noise determination threshold is a threshold for determining whether an edge is noise or an image pattern. If the edge has an intensity that is higher than the threshold, the edge is determined to be an image pattern, and if the edge has an intensity that is equal to or lower than the threshold, the edge is determined to be noise.

The noise determination threshold control unit 142 first sets an initial value of the noise determination threshold and supplies it to the vertical line extraction unit 132 for use in the processing of the first frame. In this exemplary embodiment, the noise determination threshold control unit 142 sets the same initial value to each pixel position of the frame. After that, the noise determination threshold control unit 142 adjusts the noise determination threshold based on periodicity determination result from periodicity determination unit 140 and supplies it to the vertical line extraction unit 132 for use in the processing of the subsequent frame.

Regarding the adjustment of the noise determination threshold, if a determination result indicating that there is no periodicity is supplied from periodicity determination unit 140, the noise determination threshold control unit 142 does not adjust the noise determination threshold. On the other hand, if the period boundary position is supplied from periodicity determination unit 140 determining that there is periodicity, the noise determination threshold control unit 142 sets a higher noise determination threshold for the pixel position at the period boundary and sets a lower noise determination threshold for the pixel position between the period boundaries.

The vertical line extraction unit 132, the vertical counter 134, the vertical count value adding unit 136, the block vertical boundary position determination unit 138, periodicity determination unit 140 and the noise determination threshold control unit 142 repeat the above processing until the third frame.

After that, on the fourth frame, the vertical line extraction unit 132 and the vertical counter 134 perform the same processing as the processing performed on the previous frame. The noise determination threshold which is used by the vertical counter 134, however, is possibly the one that has been adjusted from the initial value by the noise determination threshold control unit 142.

At this time, the three vertical count value storage units of the history storage unit 150 store the vertical count values of the first to third frames, respectively.

The vertical count value adding unit 136 adds the vertical count value of the fourth frame obtained by the vertical counter 134 and the vertical count values stored in the respective vertical count value storage units of the history storage unit 150 with respect to each corresponding pixel line position and outputs the result to the block vertical boundary position determination unit 138.

The peak detection unit 139 in the block vertical boundary position determination unit 138 detects peaks using each vertical count value from the vertical count value adding unit 136. The block vertical boundary position determination unit 138 determines the positions of the peaks detected by the peak detection unit 139 as block vertical boundary positions and outputs vertical boundary position information indicating the block vertical boundary positions to the sharpening processing unit 190.

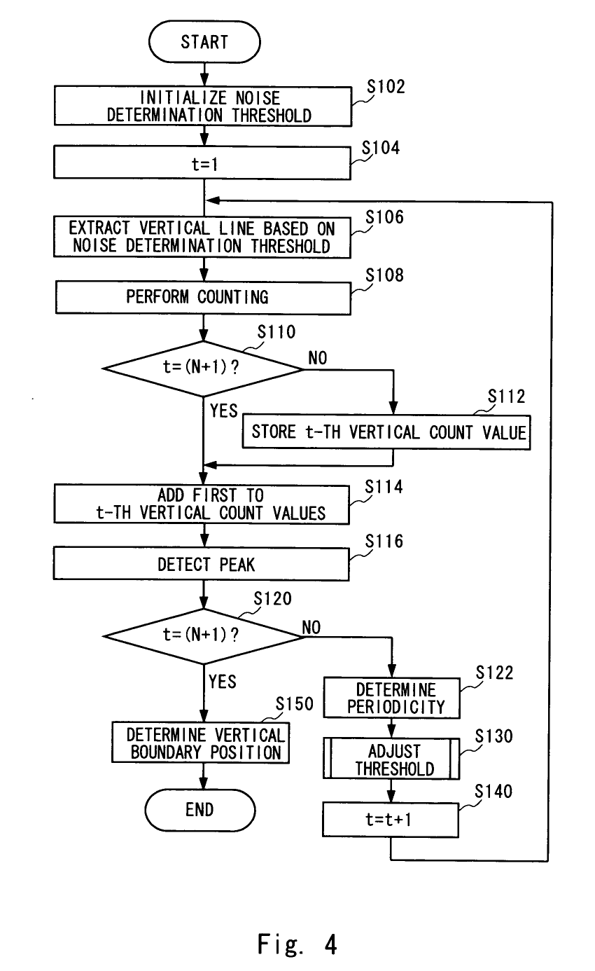

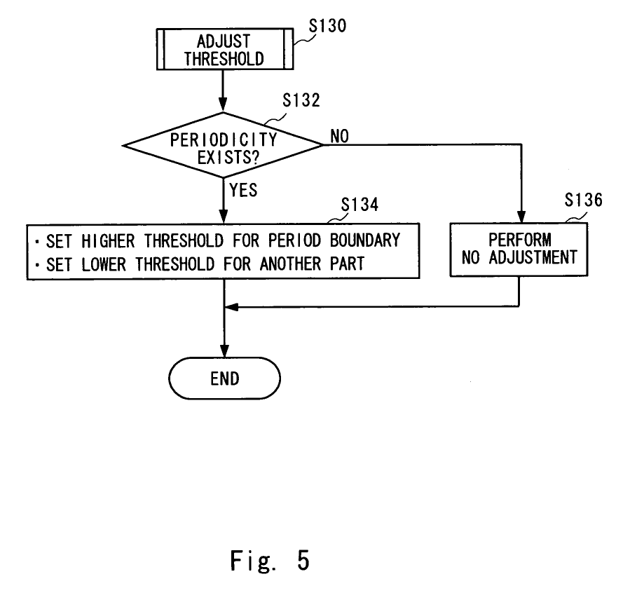

FIGS. 4 and 5 are flowcharts showing the processing of the block vertical boundary position detection unit 130 shown in FIG. 3. As shown in FIG. 4, when the block vertical boundary position detection unit 130 detects block vertical boundary positions from frames of a moving image, the noise determination threshold control unit 142 first initializes the noise determination threshold and sets the initial value to the vertical line extraction unit 132 (S102). Then, for the first frame, the vertical line extraction unit 132 extracts edges having an intensity that is equal to or lower than the noise determination threshold from the edges detected by the edge detection unit 110 with use of the noise determination threshold (which is the initial value in this step) that is set by the noise determination threshold control unit 142 (S104, S106). Then the vertical counter 134 counts the total number of edges extracted by the vertical line extraction unit 132 with respect to each pixel line position of the frame and obtains the vertical count value (S106, S108).

The vertical count value storage unit 151 stores the vertical count values of the first frame (No in S110). Although the vertical count value adding unit 136 adds the vertical count values of the first to t-th frames with respect to each corresponding pixel line position, because it is the first frame, the vertical count value adding unit 136 outputs the vertical count values obtained by the vertical counter 134 to the block vertical boundary position determination unit 138 in the step S114.

The block vertical boundary position determination unit 138 detects the peak values in the horizontal direction from the vertical cont values that are output from the vertical count value adding unit 136 and outputs the positions of the detected peaks to periodicity determination unit 140 (S116).

Periodicity determination unit 140 determines the presence or absence of periodicity of the peak positions that are output from the block vertical boundary position determination unit 138, and outputs the determination result to the noise determination threshold control unit 142 (No in S120, S122). The noise determination threshold control unit 142 adjusts the noise determination threshold based on the determination result of periodicity determination unit 140 (S130). The detail of the processing in the step S130 by the noise determination threshold control unit 142 is described later.

Next, the processing from the step S106 is performed on the second frame (S140). In the processing on the second frame, the vertical count value adding unit 136 adds the vertical count values of the second frame obtained by the vertical counter 134 and the vertical count values of the first frame stored in the vertical count value storage unit 151 with respect to each corresponding pixel line position in the step S114 and outputs the result to the block vertical boundary position determination unit 138.

The above processing is repeated until the N-number (which is three in this example) of frames. As for the fourth frame, the processing from the step S106 is performed, and, in the step S114, the vertical count value adding unit 136 adds the vertical count values of the first to fourth frames with respect to each pixel line position

Then, the block vertical boundary position determination unit 138 detects the peak values from the vertical count values added by the vertical count value adding unit 136 and determines the positions of those peak values as the block vertical boundary positions (S150).

FIG. 5 is a flowchart showing the detail of the threshold adjustment in the step S130 in FIG. 4. As shown in FIG. 5, if the determination result of periodicity determination unit 140 indicates that there is no periodicity, the noise determination threshold control unit 142 does not adjust the noise determination threshold (No in S132, S136). On the other hand, if the determination result of periodicity determination unit 140 indicates that there is periodicity, the noise determination threshold control unit 142 sets a higher noise determination threshold for the pixel position at the period boundary and sets a lower noise determination threshold for the pixel position between the period boundaries and outputs the adjusted noise determination threshold to the vertical line extraction unit 132 (Yes in S132, S134).

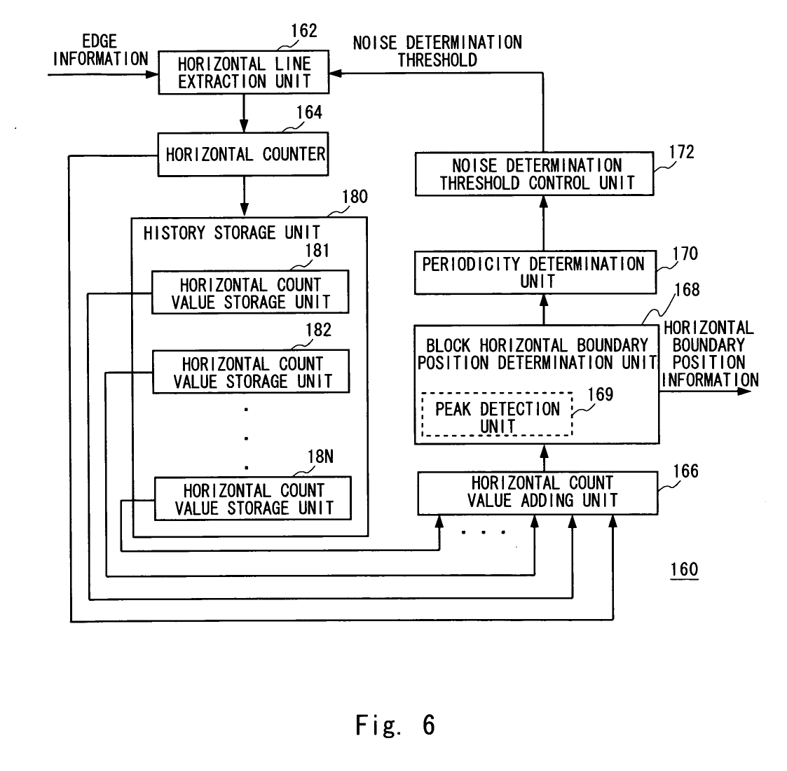

FIG. 6 shows the block horizontal boundary position detection unit 160. The block horizontal boundary position detection unit 160 includes a horizontal line extraction unit 162, a horizontal counter 164, a history storage unit 180, a horizontal count value adding unit 166, a block horizontal boundary position determination unit 168, a periodicity determination unit 170, and a noise determination threshold control unit 172. The history storage unit 180 includes N-number of horizontal count value storage units 181 to 18N, and the block horizontal boundary position determination unit 168 includes a peak detection unit 169.

The horizontal line extraction unit 162 extracts horizontal edges having an intensity that is equal to or lower than the noise determination threshold from all the edges indicated by the edge information from the edge detection unit 110, and outputs the positions of the extracted edges to the horizontal counter 164. The noise determination threshold that is used by the horizontal line extraction unit 162 is set by the noise determination threshold control unit 172 in the same manner as the noise determination threshold control unit 142.

The horizontal counter 164 counts the total number of edges extracted by the horizontal line extraction unit 162 with respect to each pixel row position of the currently processed frame and obtains a horizontal count value. The horizontal counter 164 outputs the horizontal count value of each pixel row position to the history storage unit 180 and the horizontal count value adding unit 166.

The horizontal count value storage units in the history storage unit 180, the horizontal count value adding unit 166, the block horizontal boundary position determination unit 168, periodicity determination unit 170 and the noise determination threshold control unit 172 operate in the same manner as the equivalent functional blocks in the block vertical boundary position detection unit 130 except that they process the horizontal count values, and they are thus not described in detail below.

The block horizontal boundary position determination unit 168 determines the positions of the peaks detected by the peak detection unit 169 at the completion of processing of the four frames as block horizontal boundary positions, and outputs horizontal boundary position information indicating the block horizontal boundary positions to the sharpening processing unit 190.

As described above, the edge detection unit 110 and the block boundary position detection unit 120 detect the block boundary positions using a plurality of frames and output the boundary position information to the sharpening processing unit 190.

For the frames until the boundary position information is output from the block vertical boundary position determination unit 138 (i.e. the first to fourth frames in this exemplary embodiment), the sharpening processing unit 190 performs sharpening processing at an equal level in the respective pixels based on the edge information from the edge detection unit 110. The sharpening processing may be edge enhancement processing, for example. Then, for the frames after the boundary position information is output from the block vertical boundary position determination unit 138 (i.e. the fifth and subsequent frames in this exemplary embodiment), the sharpening processing unit 190 performs sharpening processing at a lower level in the block boundary part indicated by the boundary position information than in the other part.

Typically, the intensity of an edge caused by block noise is lower than the intensity of an edge caused by an image pattern. Utilizing this, the image processing apparatus 100 according to the exemplary embodiment detects the block boundary by excluding the edge that is likely to be an image pattern (i.e. the edge having an intensity that is higher than the noise determination threshold) from the edges to be used for detecting the block boundary, thereby enabling an increase in detection accuracy.

Further, the image processing apparatus 100 detects the peak positions of the count values (the vertical count value and the horizontal count value) as block boundaries, thereby enabling detection of the block boundaries of a moving image in which the block boundaries do not appear periodically.

Further, the image processing apparatus 100 performs detection using a plurality of frames, thereby enabling a further increase in detection accuracy.

Further, when the peak positions of the count values appear periodically, the noise determination threshold for the period boundary position is adjusted to be higher and the noise determination threshold for the other position is adjusted to be lower, so that the period boundary position is likely to be determined as a block boundary, and the other position is not likely to be determined as a block boundary. This increases the accuracy of detecting the block boundaries of the moving image in which the block boundaries appear periodicity.

Further, when the image processing apparatus 100 performs sharpening processing, the intensity of processing is lowered for the block boundary part, thereby avoiding enhancement of block noise and improving image quality. Lowering the intensity of processing on the block boundary part includes not performing sharpening processing on the block boundary part.

Although four frames are used for determination of block boundaries in the image processing apparatus 100 according to the exemplary embodiment, any number of frames may be used for determination of block boundaries in the technique of the present invention.

Further, if the size of a moving image and the resolution of a playback apparatus such as a television monitor for playing back the moving image are different, it is necessary to enlarge or reduce the moving image. At this time, different enlargement or reduction ratios may be used for different parts of the image. Although different block sizes exist in the frame that is enlarged or reduced at different enlargement or reduction ratios on the different parts of the image, the block size is the same in the part with the same enlargement or reduction ratio. In the case of applying the technique of the present invention to such a moving image, the frame may be divided into a plurality of areas according to an enlargement or reduction ratio, and periodicity of peaks of count values may be detected for each area.

Further, although the image processing apparatus 100 detects the block boundary positions of a plurality of frames at the head and performs sharpening processing using the detected block boundary positions as block boundary positions of the subsequent frames, the block boundary positions may be detected for each frame. In this case also, it is preferred to detect the block boundary positions using a result of adding the count value of the current frame and the count values of the frames of one or more frames before with respect to each pixel line position or each pixel row position in order to increase detection accuracy. If is further preferred as a matter of course to use the noise determination threshold that is adjusted according to the result of periodicity determination of peak positions detected from the previous frame for the detection of the current frame.

Further, although the initial value of the noise determination threshold is the same for all pixel positions in the image processing apparatus 100 described above, a block boundary may be estimated based on a typical block size or a block size obtained by a decoder and the initial value of the noise determination threshold that is higher than that for another pixel position may be set for the pixel position at the block boundary.

Further, although the noise determination threshold control unit 142 of the block vertical boundary position detection unit 130 and the noise determination threshold control unit 172 of the block horizontal boundary position detection unit 160 are placed separately in the image processing apparatus 100 by way of illustration to facilitate understanding, the block vertical boundary position detection unit 130 and the block horizontal boundary position detection unit 160 may have one noise determination threshold control unit in common. This is the same for periodicity determination unit 140 and periodicity determination unit 170.

Further, although the vertical count value adding unit 136 adds the vertical count values of a plurality of frames with respect to each pixel line position in the above-described exemplary embodiment, an average value of the vertical count values of a plurality of frames may be calculated. This is the same for the horizontal count value adding unit 166.

While the invention has been described in terms of several exemplary embodiments, those skilled in the art will recognize that the invention can be practiced with various modifications within the spirit and scope of the appended claims and the invention is not limited to the examples described above.

Further, the scope of the claims is not limited by the exemplary embodiments described above.

Furthermore, it is noted that, Applicant's intent is to encompass equivalents of all claim elements, even if amended later during prosecution.

What is claimed is:

1. An image processing apparatus comprising:
an edge detection unit to perform edge detection on a frame of a moving image;
a vertical line extraction unit to extract a vertical edge having an intensity equal to or lower than a noise determination threshold from edges detected by the edge detection unit;
a horizontal line extraction unit to extract a horizontal edge having an intensity equal to or lower than the noise determination threshold from the edges detected by the edge detection unit;
a vertical counter to count a total number of edges extracted by the vertical line extraction unit with respect to each pixel line position of the frame;
a horizontal counter to count a total number of edges extracted by the horizontal line extraction unit with respect to each pixel row position of the frame; and
a block boundary position determination unit to determine a pixel line position having a peak of a count value of the vertical counter as a block vertical boundary position and determine a pixel row position having a peak of a count value of the horizontal counter as a block horizontal boundary position.

2. The image processing apparatus according to claim 1, further comprising:
a vertical count value adding unit to add count values of the vertical counter with respect to a corresponding pixel line position of a plurality of frames; and
a horizontal count value adding unit to add count values of the horizontal counter with respect to a corresponding pixel row position of the plurality of frames, wherein
the block boundary position determination unit determines a pixel line position having a peak of a count value obtained by the vertical count value adding unit as the block vertical boundary position and determines a pixel row position having a peak of a count value obtained by the horizontal count value adding unit as the block horizontal boundary position.

3. The image processing apparatus according to claim 1, further comprising:
a periodicity determination unit to determine presence or absence of periodicity of peaks of a count value in each pixel line position and presence or absence of periodicity of peaks of a count value in each pixel row position; and
a noise determination threshold control unit to, if the periodicity determination unit determines that periodicity is present, set a higher noise determination threshold than a current noise determination threshold for a pixel position at a period boundary and set a lower noise determination threshold than the current noise determination threshold for another pixel position and supply the noise determination thresholds for use in processing of a subsequent frame by the vertical line extraction unit and the horizontal line extraction unit.

4. The image processing apparatus according to claim 2, further comprising:
a periodicity determination unit to determine presence or absence of periodicity of peaks of a count value in each pixel line position and presence or absence of periodicity of peaks of a count value in each pixel row position; and
a noise determination threshold control unit to, if the periodicity determination unit determines that periodicity is present, set a higher noise determination threshold than a current noise determination threshold for a pixel position at a period boundary and set a lower noise determination threshold than the current noise determination threshold for another pixel position and supply the noise determination thresholds for use in processing of a subsequent frame by the vertical line extraction unit and the horizontal line extraction unit.

5. The image processing apparatus according to claim 3, wherein
the periodicity determination unit divides the frame into a plurality of areas in at least one of a vertical direction and a horizontal direction and determines presence or absence of the periodicity with respect to each area.

6. The image processing apparatus according to claim 4, wherein
the periodicity determination unit divides the frame into a plurality of areas in at least one of a vertical direction and a horizontal direction and determines presence or absence of the periodicity with respect to each area.

7. The image processing apparatus according to claim 1, further comprising:
a sharpening processing unit to perform sharpening processing on the frame of the moving image, wherein
the sharpening processing unit performs sharpening processing at a lower level on a part determined as a block boundary position by the block boundary position determination unit than on another part.

8. The image processing apparatus according to claim 2, further comprising:
a sharpening processing unit to perform sharpening processing on the frame of the moving image, wherein
the sharpening processing unit performs sharpening processing at a lower level on a part determined as a block boundary position by the block boundary position determination unit than on another part.

9. The image processing apparatus according to claim 3, further comprising:
a sharpening processing unit to perform sharpening processing on the frame of the moving image, wherein
the sharpening processing unit performs sharpening processing at a lower level on a part determined as a block boundary position by the block boundary position determination unit than on another part.

10. The image processing apparatus according to claim 4, further comprising:
a sharpening processing unit to perform sharpening processing on the frame of the moving image, wherein
the sharpening processing unit performs sharpening processing at a lower level on a part determined as a block boundary position by the block boundary position determination unit than on another part.

11. The image processing apparatus according to claim 5, further comprising:
a sharpening processing unit to perform sharpening processing on the frame of the moving image, wherein
the sharpening processing unit performs sharpening processing at a lower level on a part determined as a block boundary position by the block boundary position determination unit than on another part.

12. The image processing apparatus according to claim 6, further comprising:
a sharpening processing unit to perform sharpening processing on the frame of the moving image, wherein
the sharpening processing unit performs sharpening processing at a lower level on a part determined as a block boundary position by the block boundary position determination unit than on another part.

13. An image processing method comprising:
performing edge detection on a frame of a moving image;
extracting a vertical edge having an intensity equal to or lower than a noise determination threshold from edges detected by the edge detection;
extracting a horizontal edge having an intensity equal to or lower than the noise determination threshold from the edges detected by the edge detection;
counting a total number of edges extracted by the vertical edge extraction with respect to each pixel line position of the frame;
counting a total number of edges extracted by the horizontal edge extraction with respect to each pixel row position of the frame; and
determining a block boundary position by determining a pixel line position having a peak of a count value obtained by the vertical counting as a block vertical boundary position and determining a pixel row position having a peak of a count value obtained by the horizontal counting as a block horizontal boundary position.

14. A program causing a computer to implement a method comprising:
performing edge detection on a frame of a moving image;
extracting a vertical edge having an intensity equal to or lower than a noise determination threshold from edges detected by the edge detection;
extracting a horizontal edge having an intensity equal to or lower than the noise determination threshold from the edges detected by the edge detection;
counting a total number of edges extracted by the vertical edge extraction with respect to each pixel line position of the frame;
counting a total number of edges extracted by the horizontal edge extraction with respect to each pixel row position of the frame; and
determining a block boundary position by determining a pixel line position having a peak of a count value obtained by the vertical counting as a block vertical boundary position and determining a pixel row position having a peak of a count value obtained by the horizontal counting as a block horizontal boundary position.
